(19) United States
(12) Patent Application Publication
(10) Pub. No.: US 2024/0286221 A1
(43) Pub. Date: Aug. 29, 2024

(54) LASER WELDING APPARATUS

(71) Applicants: TOYOTA JIDOSHA KABUSHIKI KAISHA, Toyota-shi (JP); CENTRAL ENGINEERING CO., LTD., Yokohama-shi (JP)

(72) Inventors: Hiroaki IKEGAMI, Okazaki-shi (JP); Mitsutaka YOSHIDA, Nagakute-shi (JP); Takeshi GOGAMI, Okazaki-sh (JP); Akifumi OSUGI, Toyota-shi (JP)

(73) Assignees: TOYOTA JIDOSHA KABUSHIKI KAISHA, Toyota-shi (JP); CENTRAL ENGINEERING CO., LTD., Yokohama-shi (JP)

(21) Appl. No.: 18/585,518

(22) Filed: Feb. 23, 2024

(30) Foreign Application Priority Data
Feb. 27, 2023 (JP) 2023-028184

(51) Int. Cl. B23K 26/21; B23K 26/082; B23K 26/12

(52) U.S. Cl. CPC B23K 26/21; B23K 26/082; B23K 26/123

(57) ABSTRACT

A laser welding apparatus capable of eliminating or reducing a possibility that a part of air flows upward and hence fumes adhere to its protective optical member is provided. A laser welding apparatus according to the present disclosure includes a protective optical member disposed between a laser scanner and a workpiece, an upper-side gas supply unit, and a lower-side gas supply unit disposed below the upper-side gas supply unit. The protective optical member includes a plate-like part and a cylindrical part extending downward from an outer edge of the plate-like part. The upper-side gas supply unit is disposed below the plate-like part of the protective optical member. The upper-side gas supply unit includes a plurality of first ejection ports configured to eject gas to a center of the plate-like part, and a plurality of second ejection ports configured to eject gas downward with respect to the plate-like part.

### CROSS REFERENCE TO RELATED APPLICATIONS

This application is based upon and claims the benefit of priority from Japanese patent application No. 2023-028184, filed on Feb. 27, 2023, the disclosure of which is incorporated herein in its entirety by reference.

### BACKGROUND

The present disclosure relates to a laser welding apparatus.

A laser welding apparatus disclosed in Japanese Unexamined Patent Application Publication No. 2018-202441 includes an air-blow unit that makes air flow in a direction crossing an optical path of laser light emitted from a laser scanner main body. According to the document, this air flow prevents spatters scattered from a place on a workpiece where the laser is applied during the laser welding process from adhering to (or being deposited on) a protective glass attached near an emission opening of the laser scanner main body.

### SUMMARY

The inventors of the present application have found the following problem. In the above-described laser welding apparatus, a part of air may flow upward.

In such a case, fumes may adhere to (or be deposited on) a protective optical member such as the protective glass.

The present disclosure has been made in view of the above-described problem, and an object thereof is to provide a laser welding apparatus capable of eliminating or reducing the possibility that a part of air flows upward and hence fumes adhere to (or are deposited on) its protective optical member.

In an aspect, a laser welding apparatus includes:
a laser scanner; and
a protective optical member disposed between the laser scanner and a workpiece, in which
the laser welding apparatus further includes:
an upper-side gas supply unit; and
a lower-side gas supply unit disposed below the upper-side gas supply unit, the protective optical member includes a plate-like part and a cylindrical part extending downward from an outer edge of the plate-like part,
the upper-side gas supply unit is disposed below the plate-like part of the protective optical member,
the upper-side gas supply unit includes a plurality of first ejection ports configured to eject gas to a center of the plate-like part, and a plurality of second ejection ports configured to eject gas downward with respect to the plate-like part,
the cylindrical part is disposed between the upper-side gas supply unit and the lower-side gas supply unit, and includes a plurality of gas feeding ports for feeding gas from an outside of the cylindrical part into an inside thereof, and
the lower-side gas supply unit includes a plurality of lower-side ejection ports configured to eject gas downward from a lower end of the cylindrical part.

According to the above-described configuration, since the plurality of first ejection ports eject gas from the outer edge of the plate-like part to the center thereof, the underside of the plate-like part of the protective optical member is covered with the gas. The gas flows downward at the center. Further, the plurality of second ejection ports eject gas downward from the outer edge of the plate-like part. The plurality of ejection ports of the lower-side gas supply unit eject gas downward. The plurality of gas feeding ports feed air from the outside of the cylindrical part into the inside thereof. These flows of gas prevent any of air from flowing upward. Therefore, it is possible to eliminate or reduce the possibility that fumes adhere to (or are deposited on) a protective optical member.

Further, the plurality of second ejection ports may eject gas from the outer edge of the plate-like part in a direction inclined toward an optical axis of the laser. Further, the plurality of second ejection ports may eject gas from the outer edge of the plate-like part in a direction parallel to an optical axis of the laser.

According to the present disclosure, it is possible to eliminate or reduce a possibility that a part of air flows upward and hence fumes adhere to (or are deposited on) a protective optical member.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a plan view of a laser welding apparatus according to a first embodiment;

FIG. 2 is a cross-sectional view of the laser welding apparatus according to the first embodiment;

FIG. 3 is a perspective view of an upper-side gas supply unit of the laser welding apparatus according to the first embodiment;

FIG. 4 is a perspective view of a lower-side gas supply unit of the laser welding apparatus according to the first embodiment;

FIG. 5 is a perspective view of an upper-side gas supply unit of a modified example of the laser welding apparatus according to the first embodiment;

FIG. 6 shows places where a flow velocity was analyzed in an example;

FIG. 7A shows a result of an analysis of a flow velocity in Example 1;

FIG. 7B shows a result of an analysis of a flow velocity in Example 2;

FIG. 7C shows a result of an analysis of a flow velocity in Comparative Example 1;

FIG. 8 shows places where a flow velocity was analyzed in an example;

FIG. 9 shows a cross section where the flow velocity was analyzed in the example;

FIG. 10 shows results of analyses of flow velocities in the example;

FIG. 11 is a graph showing results of measurements or analyses of flow velocities below a protective optical member of a laser welding apparatus according to an example and the like;

FIG. 12 is a plan view of a laser welding apparatus according to a technology related to the present disclosure;

FIG. 13 is a cross-sectional view of the laser welding apparatus according to the technology related to the present disclosure;

FIG. 14 is a perspective view of a key part of the laser welding apparatus according to the technology related to the present disclosure; and

FIG. 15 is a perspective view of a key part of the laser welding apparatus according to the technology related to the present disclosure.

### DESCRIPTION OF EMBODIMENTS

### Related Technology

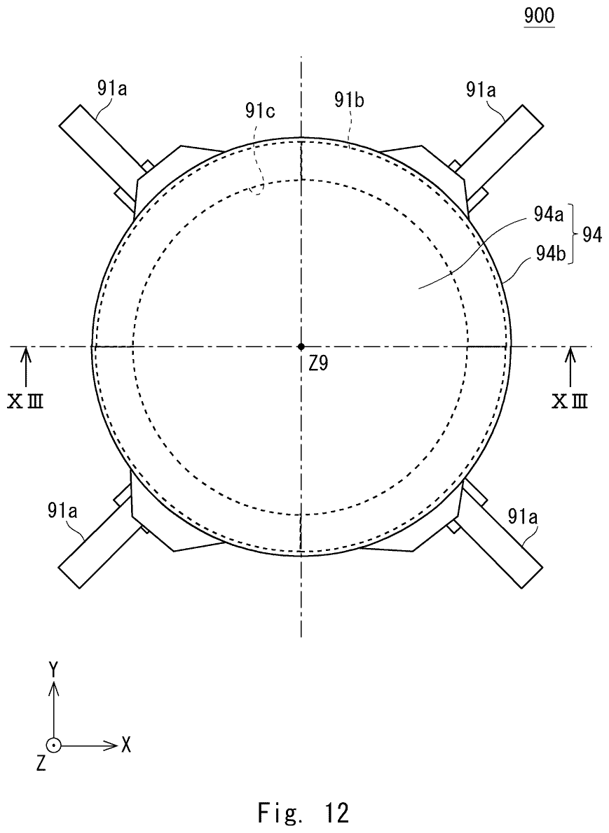

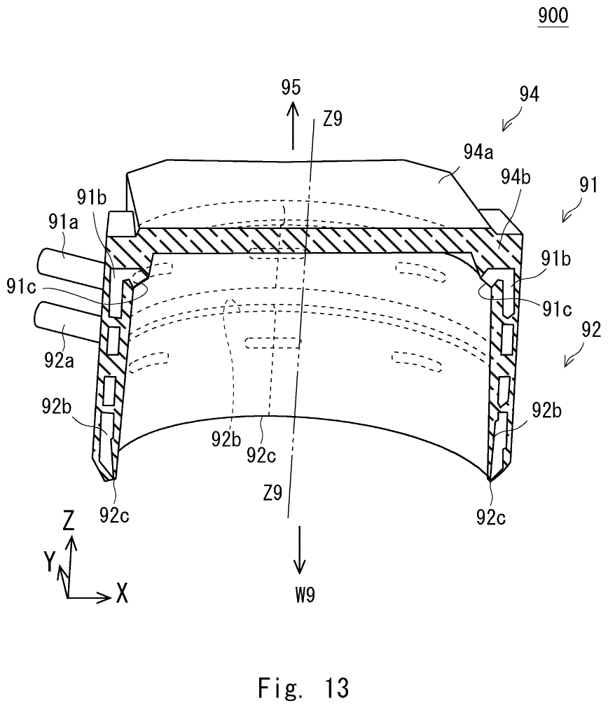

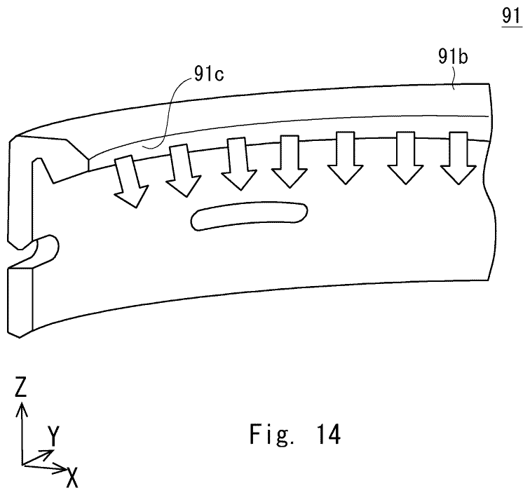

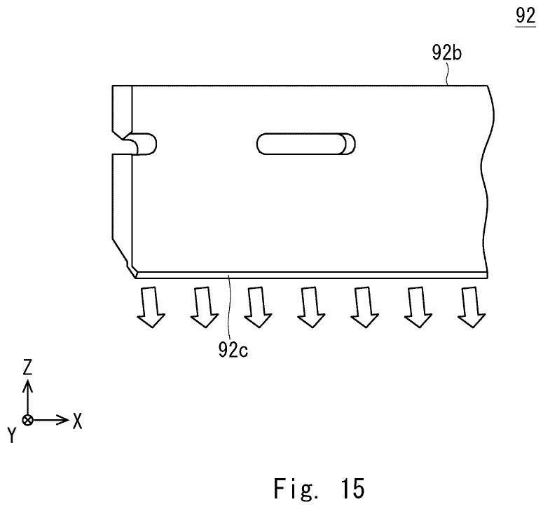

Prior to describing a specific embodiment to which the present disclosure is applied, a laser welding apparatus according to a technology related to the present disclosure will be described with reference to FIGS. 12 to 15. FIG. 12 is a plan view of a laser welding apparatus according to a technology related to the present disclosure. FIG. 13 is a cross-sectional view of the laser welding apparatus shown in FIG. 12. FIG. 14 is a perspective view of an upper-side gas supply unit of the laser welding apparatus shown in FIG. 12. FIG. 15 is a perspective view of a lower-side gas supply unit of the laser welding apparatus shown in FIG. 12. Note that in FIG. 13, regarding the laser scanner 95 and the workpiece W9, only their reference numerals are shown and the illustration of the components themselves are omitted.

As shown in FIGS. 12 and 13, a laser welding apparatus 900 includes an upper-side gas supply unit 91, a lower-side gas supply unit 92, a protective optical member 94, and a laser scanner 95.

The protective optical member 94 is disposed between the laser scanner 95 and a workpiece W9. The protective optical member 94 includes a plate-like part 94a and a cylindrical part 94b. The plate-like part 94a is disposed directly below the laser scanner 95. The cylindrical part 94b extends downward from the outer edge of the plate-like part 94a. The plate-like part 94a closes (i.e., covers) the opening of the upper end of the cylindrical part 94b. An axis Z9 of the cylindrical part 94b passes through the center of the plate-like part 94a.

The upper-side gas supply unit 91 is disposed below the plate-like part 94a of the protective optical member 94. The lower-side gas supply unit 92 is disposed below the upper-side gas supply unit 91. The upper-side gas supply unit 91 and the lower-side gas supply unit 92 are generally disposed inside the cylindrical part 94b of the protective optical member 94.

The upper-side gas supply unit 91 includes connection pipes 91a, flow paths 91b, and one obliquely-downward ejection port 91c. The connection pipes 91a, the flow paths 91b, and the obliquely-downward ejection port 91c communicate with each other, and gas can move inside them. Gas is supplied from an external apparatus to the connection pipes 91a, and the flow paths 91b guide the supplied gas to the obliquely-downward ejection port 91c. As shown in FIGS. 13 and 14, the obliquely-downward ejection port 91c is opened on the inner peripheral surface of the cylindrical part 94b. The obliquely-downward ejection port 91c ejects the guided gas in an obliquely downward direction, specifically, to the lower side of the cylindrical part 94b and toward the axis Z9 thereof.

The lower-side gas supply unit 92 includes connection pipes 92a, flow paths 92b, and one obliquely-downward ejection port 92c. The connection pipes 92a, the flow paths 92b, and the obliquely-downward ejection port 92c communicate with each other, and gas can move inside them. Gas is supplied from an external apparatus (not shown) to the connection pipes 92a, and the flow paths 92b guide the supplied gas to the obliquely-downward ejection port 92c. As shown in FIGS. 13 and 15, the obliquely-downward ejection port 92c is opened on the inner peripheral surface of the cylindrical part 94b and extends in the circumferential direction. The obliquely-downward ejection port 92c ejects the guided gas in an obliquely downward direction, specifically, to the lower side of the cylindrical part 94b and toward the axis Z9 thereof.

Note that the laser scanner 95 emits a laser along the axis Z9 of the cylindrical part 94b. Then, as the laser scanner 95 emits a laser, and this laser passes through the inner space of the plate-like part 94a and the cylindrical part 94b of the protective optical member 94 and is applied to the workpiece W9. In this way, it is possible to melt a part of the workpiece W9 and thereby to carry out welding. Further, fumes are generated from the molten part of the workpiece W9.

While the laser scanner 95 is emitting the laser, the obliquely-downward ejection port 91c and the obliquely-downward ejection port 92c eject gas in the obliquely downward direction as described above. Therefore, even if fumes are generated, most of the fumes are made to flow downward with respect to the cylindrical part 94b by this ejection of gas. However, a part of the air sometimes flows upward in a part of the inner space of the cylindrical part 94b. In such a case, there is a possibility that a part of the fumes flow toward the plate-like part 94a and adhere to (or are deposited on) the protective optical member 94.

A specific embodiment to which the present disclosure is applied will be described hereinafter in detail with reference to the drawings. However, the present disclosure is not limited to the below-shown embodiments. Further, for clarifying the explanation, the following descriptions and drawings are simplified as appropriate.

### First Embodiment

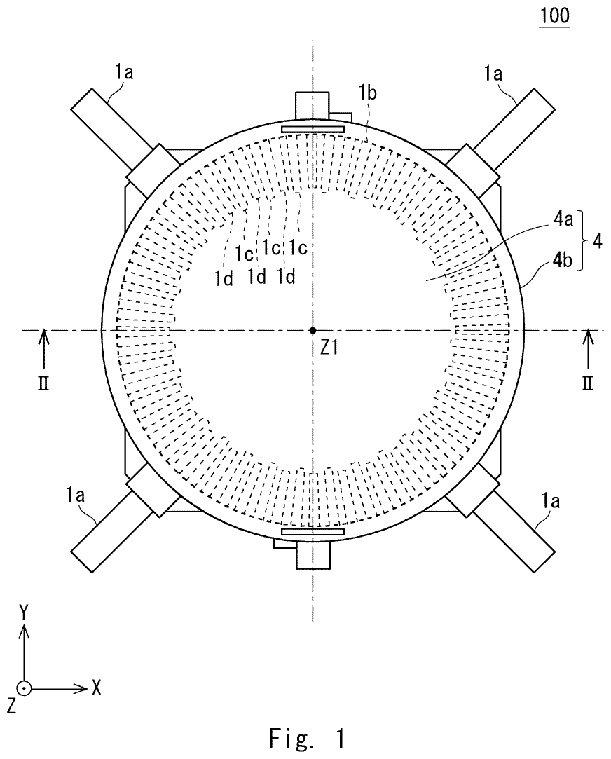

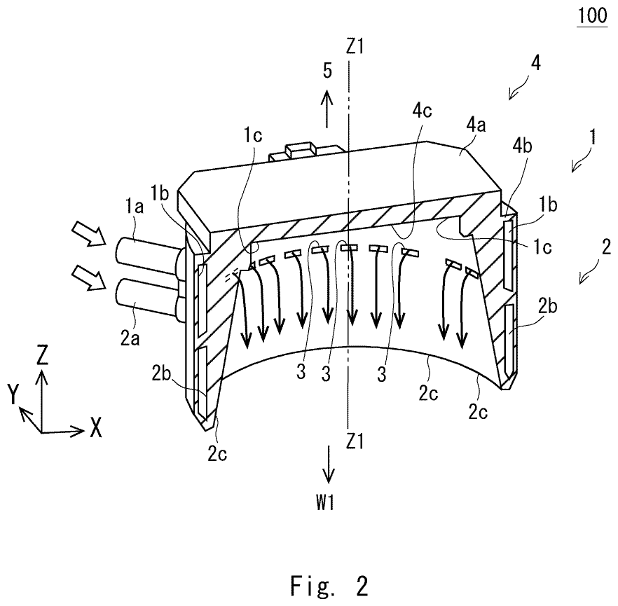

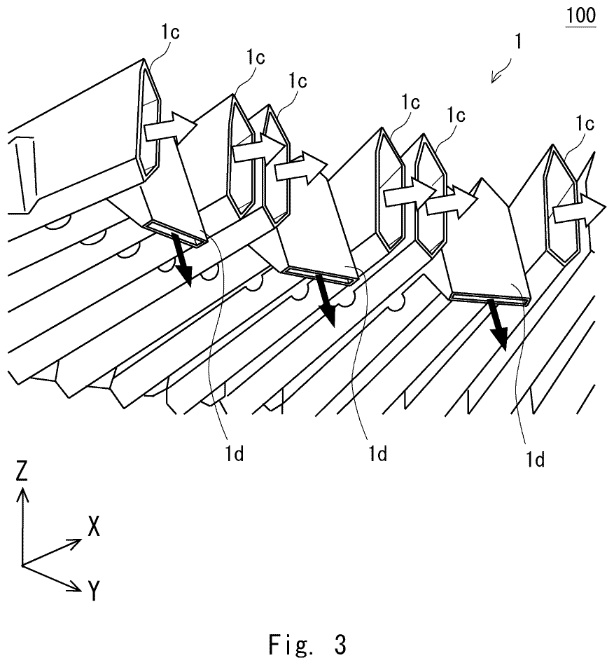

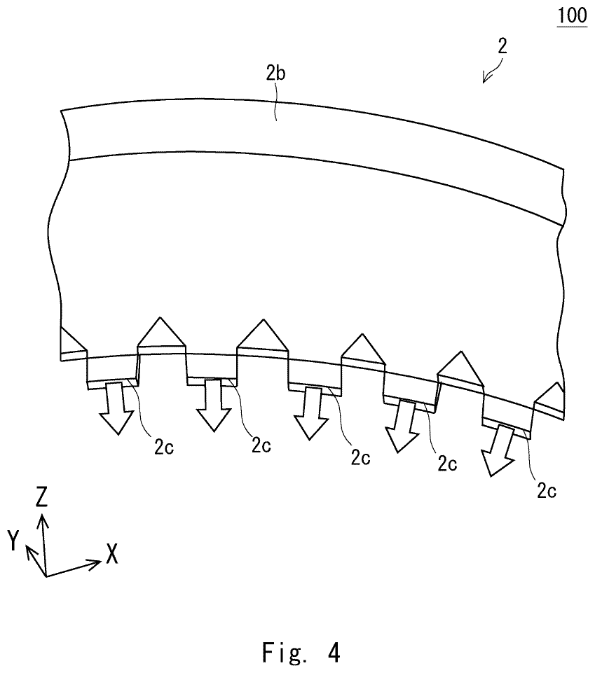

A first embodiment will be described with reference to FIGS. 1 to 4. FIG. 1 is a plan view of a laser welding apparatus according to a first embodiment. FIG. 2 is a cross-sectional view of the laser welding apparatus shown in FIG. 1. FIG. 3 is a perspective view of an upper-side gas supply unit of the laser welding apparatus shown in FIG. 1. FIG. 4 is a perspective view of a lower-side gas supply unit of the laser welding apparatus shown in FIG. 1. Note that in FIG. 2, regarding the laser scanner 5 and the workpiece W1, only their reference numerals are shown and the illustrations of the components themselves are omitted.

Note that, needless to say, right-handed XYZ coordinate systems shown in FIG. 1 and other drawings are shown just for explaining the positional relationship among components. In general, a Z-axis positive direction is vertically upward and an XY-plane is a horizontal plane, and they apply to all of the drawings.

As shown in FIGS. 1 and 2, a laser welding apparatus 100 includes an upper-side gas supply unit 1, a lower-side gas supply unit 2, a protective optical member 4, and a laser scanner 5.

The protective optical member 4 is a member made of a glass material that allows laser to pass therethrough, and is, for example, a protective glass. The protective optical member 4 is disposed between the laser scanner 5 and the workpiece W1. The protective optical member 4 includes a plate-like part 4a and a cylindrical part 4b. The plate-like part 4a is disposed below the laser scanner 5 (in this example, the Z-axis negative direction with respective to the laser scanner 5). The cylindrical part 4b extends downward from the outer edge of the plate-like part 4a. The cylindrical part 4b is preferably a cylindrical body. The plate-like part 4a closes (i.e., covers) the opening at the upper end of the cylindrical part 4b. An axis Z1 of the cylindrical part 4b passes through the center of the plate-like part 4a.

Note that the plate-like part 4a and the cylindrical part 4b may be components separate from each other rather than being one integral component. In the case where the plate-like part 4a and the cylindrical part 4b are components separate from each other, it is preferable that the plate-like part 4a and the cylindrical part 4b be in close contact with each other so that gas hardly passes between the plate-like part 4a and the cylindrical part 4b. Further, the cylindrical part 4b may be made of a material that does not allow laser pass therethrough.

The upper-side gas supply unit 1 is disposed below the plate-like part 4a of the protective optical member 4. The lower-side gas supply unit 2 is disposed below the upper-side gas supply unit 1. The upper-side gas supply unit 1 and the lower-side gas supply unit 2 are preferably disposed inside the cylindrical part 4b of the protective optical member 4.

As shown in FIGS. 1 to 3, the upper-side gas supply unit 1 includes connection pipes 1a, flow paths 1b, a plurality of first ejection ports 1c, and a plurality of second ejection ports 1d. In the example shown in FIG. 1, the upper-side gas supply unit 1 includes four connection pipes 1a. The connection pipes 1a, the flow paths 1b, the plurality of first ejection ports 1c, and the plurality of second ejection ports 1d communicate with each other, and gas can move inside the connection pipes 1a, the flow paths 1b, the plurality of first ejection ports 1c, and the plurality of second ejection ports 1d. Examples of gas that can be used as the aforementioned gas include air and inert gases.

The flow paths 1b extends in a ring shape inside the cylindrical part 4b. The connection pipes 1a project from the flow paths 1b to the outside of the protective optical member 4 through the outer peripheral surface of the cylindrical part 4b. The first ejection ports 1c and the second ejection ports 1d face, from the flow paths 1b, the inside of the cylindrical part 4b. The plurality of first ejection ports 1c and the plurality of second ejection ports 1d are arranged along the outer edge of the plate-like part 4a of the protective optical member 4. For example, as shown in FIG. 1, the plurality of first ejection ports 1c and the plurality of second ejection ports 1d may be arranged alternately along the outer edge of the plate-like part 4a of the protective optical member 4. Further, as shown in FIG. 3, for example, a plurality of sets each of which consists of two first ejection ports 1c and one second ejection port 1d may be continuously arranged along the outer edge of the plate-like part 4a of the protective optical member 4.

Gas is supplied from an external apparatus (not shown) to the flow paths 1b through the connection pipes 1a. The flow paths 1b guide the supplied gas to the plurality of first ejection ports 1c and the plurality of second ejection ports 1d.

The plurality of first ejection ports 1c eject the gas guided from the flow paths 1b from the outer edge of the plate-like part 4a of the protective optical member 4 to the center thereof.

The plurality of second ejection ports 1d eject the gas guided from the flow paths 1b downward from the outer edge of the plate-like part 4a. Specifically, the plurality of second ejection ports 1d eject gas guided from the flow paths 1b in a direction inclined from the outer edge of the plate-like part 4a toward the optical axis of the laser.

The lower-side gas supply unit 2 includes connection pipes 2a, flow paths 2b, and a plurality of ejection ports 2c. The connection pipes 2a, the flow paths 2b, and the plurality of ejection ports 2c communicate with each other, and gas can move inside the connection pipes 2a, the flow paths 2b, and the plurality of ejection ports 2c. Examples of gas that can be used as the aforementioned gas include air and inert gases.

The flow paths 2b extends in the circumferential direction inside the cylindrical part 4b. The connection pipes 2a project from the flow paths 2b to the outside of the protective optical member 4 through the outer peripheral surface of the cylindrical part 4b. The plurality of ejection ports 2c may project from flow paths 2b to the lower end of the cylindrical part 4b. The plurality of ejection ports 2c may be opened at the lower end of the cylindrical part 4b. The plurality of ejection ports 2c are arranged along the lower end of the cylindrical part 4b of the protective optical member 4. For example, as shown in FIG. 4, the plurality of ejection ports 2c may be arranged at predetermined intervals along the lower end of the cylindrical part 4b of the protective optical member 4.

Gas is supplied from an external apparatus (not shown) to the flow paths 2b through the connection pipes 2a. The flow paths 2b guide the supplied gas to the plurality of ejection ports 2c.

The plurality of ejection ports 2c eject gas downward from the lower end of the cylindrical part 4b. Specifically, the plurality of ejection ports 2c may eject gas downward from the lower end of the cylindrical part 4b toward the axis Z1 of the cylindrical part 4b. The total area of the openings of the plurality of ejection ports 2c is preferably smaller than the area of the opening of the obliquely-downward ejection port 92c shown in FIGS. 13 and 15.

The cylindrical part 4b has a plurality of gas feeding ports 3. The plurality of gas feeding ports 3 are disposed between the upper-side gas supply unit 1 and the lower-side gas supply unit 2. The plurality of gas feeding ports 3 are preferably arranged at predetermined intervals in the circumferential direction of the cylindrical part 4b. The plurality of gas feeding ports 3 penetrate the cylindrical part 4b (i.e., the wall of the cylindrical part 4b). Gas can move from the outside of the cylindrical part 4b to the inside of the cylindrical part 4b through the plurality of gas feeding ports 3. In other words, the plurality of gas feeding ports 3 can feed gas from the outside of the cylindrical part 4b into the inside thereof. The aforementioned gas is a welding atmosphere, and examples thereof include air and inert gases.

The laser scanner 5 is disposed above the protective optical member 4 so that laser can pass through the plate-like part 4a and is applied to the workpiece W1.

Note that while air is being ejected, as the gas, from the plurality of first ejection ports 1c, the plurality of second ejection ports 1d, and the plurality of ejection ports 2c, the laser scanner 5 emits a laser toward the workpiece W1. Then, the emitted laser passes through the center of the plate-like part 4a of the protective optical member 4, travels along the axis Z1 of the cylindrical part 4b, and is applied to the workpiece W1. A part of the workpiece W1 is melted, so that welding is carried out. Fumes are generated by this melting. Since the plurality of first ejection ports 1c eject gas from the outer edge of the plate-like part 4a to the center thereof, the underside of the plate-like part 4a is covered by the gas, and the gas is collected at the center of the plate-like part 4a and then flows downward with respect to the plate-like part 4a. In this way, it is possible to prevent fumes from moving closer to the plate-like part 4a. Further, the plurality of second ejection ports 1d eject gas downward from the outer edge of the plate-like part 4a, and the plurality of ejection ports 2c eject gas downward from the lower end of the cylindrical part 4b. Further, the plurality of gas feeding ports 3 feed gas from the outside of the cylindrical part 4b into the inside thereof. By making gas flow downward by the above-described features, it is possible to prevent fumes from flowing to the plate-like part 4a. In this way, it is possible to eliminate or reduce the possibility that fumes adhere to (or are deposited on) the protective optical member. Further, by preventing fumes from adhering to (or being deposited on) the protective optical member, the quality of welding can be ensured.

### Modified Example

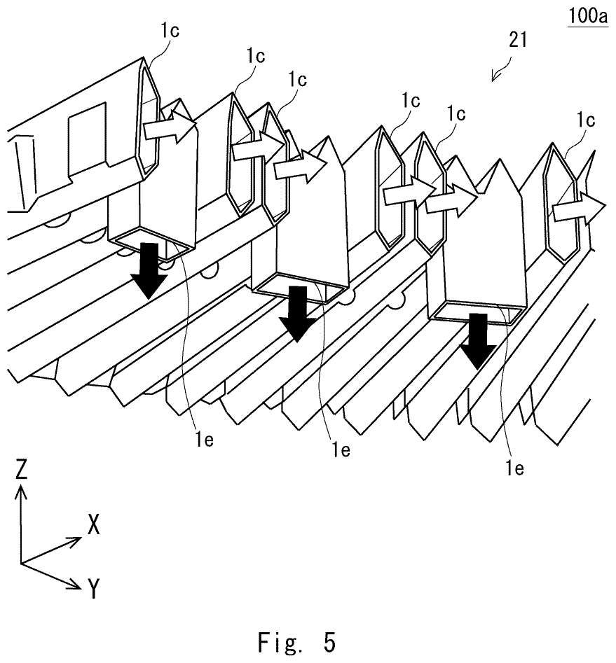

A modified example of the laser welding apparatus according to the first embodiment will be described with reference to FIG. 5. FIG. 5 is a perspective view of a modified example of an upper-side gas supply unit of a modified example of the laser welding apparatus shown in FIG. 3.

The laser welding apparatus 100a shown in FIG. 5 has the same configuration as that of the laser welding apparatus 100 shown in FIGS. 1 to 4 except for the upper-side gas supply unit 1 of the laser welding apparatus 100. The laser welding apparatus 100a includes an upper-side gas supply unit 21. The upper-side gas supply unit 21 has the same configuration as the upper-side gas supply unit 1 shown in FIG. 3 except that the upper-side gas supply unit 21 includes third ejection ports 1e in place of the second ejection ports 1d shown in FIG. 3.

The upper-side gas supply unit 21 includes a plurality of first ejection ports 1c and a plurality of third ejection ports 1e in addition to the connection pipes 1a and the flow paths 1b shown in FIG. 1. The plurality of third ejection ports 1e have the same configuration as that of the plurality of second ejection ports 1d shown in FIG. 1 except for the direction in which gas is ejected. The plurality of third ejection ports 1e eject gas guided from the flow paths 1b from the outer edge of the plate-like part 4a in a direction parallel to the optical axis of the laser (in this example, in the Z-axis negative direction). Compared to the second ejection ports 1d shown in FIG. 3, the third ejection ports 1e can make gas flow strongly downward from the outer edge of the plate-like part 4a.

Note that the connection pipes 1a, the flow paths 1b, the plurality of first ejection ports 1c, and the plurality of third ejection ports 1e communicate with each other, and gas can move inside the connection pipes 1a, the flow paths 1b, the plurality of first ejection ports 1c, and the plurality of third ejection ports 1e. Examples of gas that can be used as the aforementioned gas include air and inert gases. Further, the first ejection port 1c and the plurality of third ejection ports 1e face, from the flow paths 1b, the inside of the cylindrical part 4b. The plurality of first ejection ports 1c and the plurality of third ejection ports 1e are arranged along the outer edge of the plate-like part 4a of the protective optical member 4. For example, similarly to the plurality of first ejection ports 1c and the plurality of second ejection ports 1d shown in FIG. 1, the plurality of first ejection ports 1c and the plurality of third ejection ports 1e may be arranged alternately along the outer edge of the plate-like part 4a of the protective optical member 4. Further, for example, as shown in FIG. 5, a plurality of sets each of which consists of two first ejection ports 1c and one third ejection ports 1e may be continuously arranged along the outer edge of the plate-like part 4a of the protective optical member 4. The flow paths 1b guide gas supplied from an external apparatus (not shown) through the connection pipes 1a to the plurality of first ejection ports 1c and the plurality of third ejection ports 1e.

Note that while air is being ejected, as the gas, from the plurality of first ejection ports 1c, the plurality of third ejection ports 1e, and the plurality of ejection ports 2c, the laser scanner 5 emits a laser toward the workpiece W1. Then, the emitted laser passes through the center of the plate-like part 4a of the protective optical member 4, travels along the axis Z1 of the cylindrical part 4b, and is applied to the workpiece W1. A part of the workpiece W1 is melted, so that welding is carried out. Fumes are generated by this melting. Since the plurality of first ejection ports 1c eject gas from the outer edge of the plate-like part 4a to the center thereof, the underside of the plate-like part 4a is covered by the gas, and the gas is collected at the center of the plate-like part 4a and then flows downward with respect to the plate-like part 4a. In this way, it is possible to prevent fumes from moving closer to the plate-like part 4a. Further, the plurality of ejection ports 2c eject gas downward from the lower end of the cylindrical part 4b. Further, the plurality of gas feeding ports 3 feed gas from the outside of the cylindrical part 4b into the inside thereof. Compared to the second ejection ports 1d shown in FIG. 3, the third ejection ports 1e can make gas flow strongly downward from the outer edge of the plate-like part 4a. In this way, it is possible to increase the velocity at which the gas flows downward, and to prevent fumes from flowing to the plate-like part 4a more effectively.

### Example

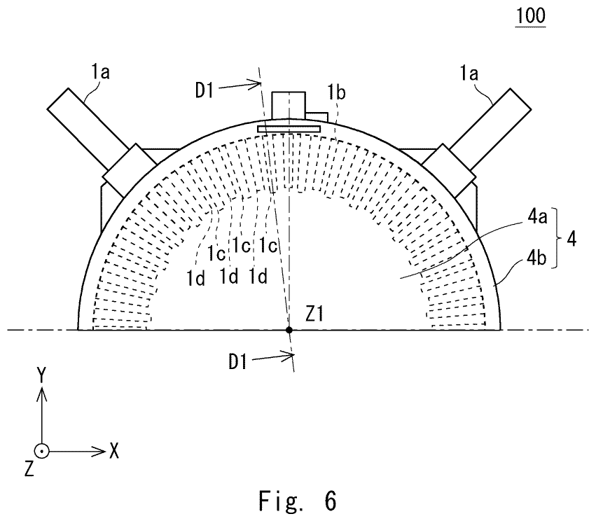

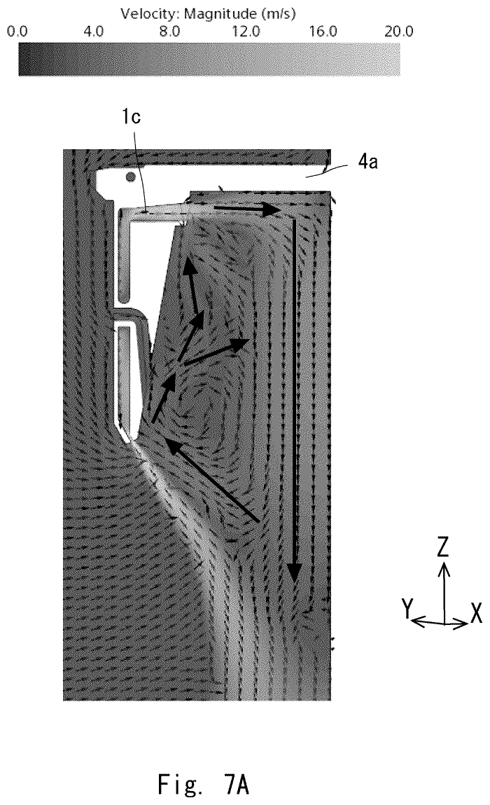

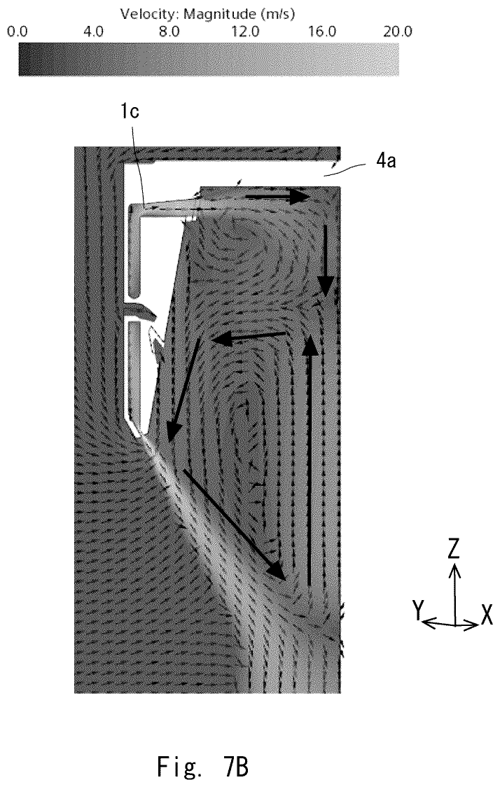

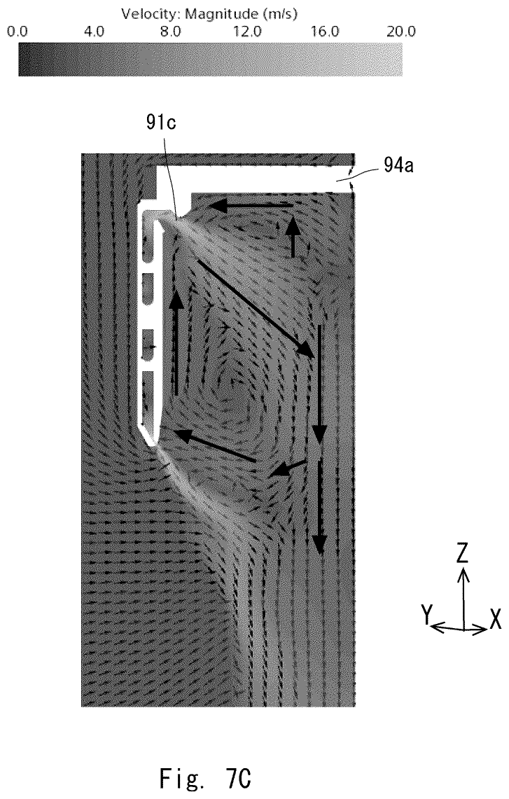

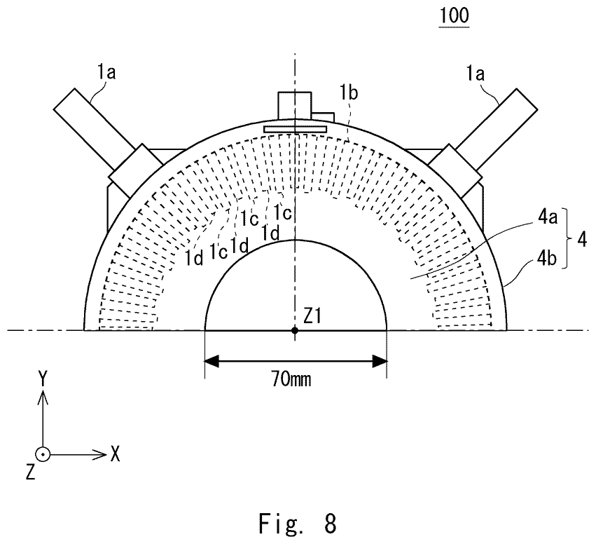

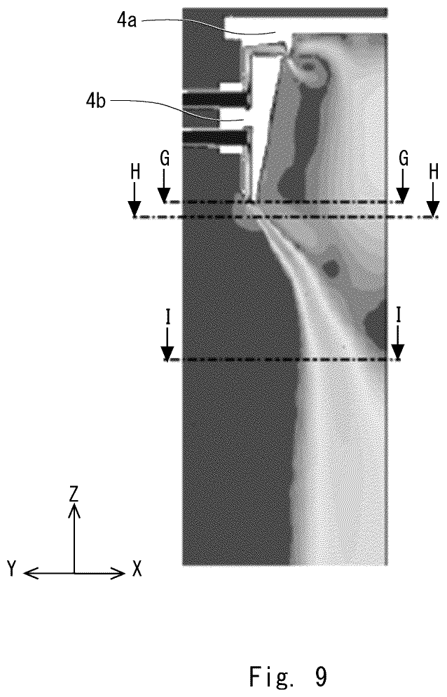

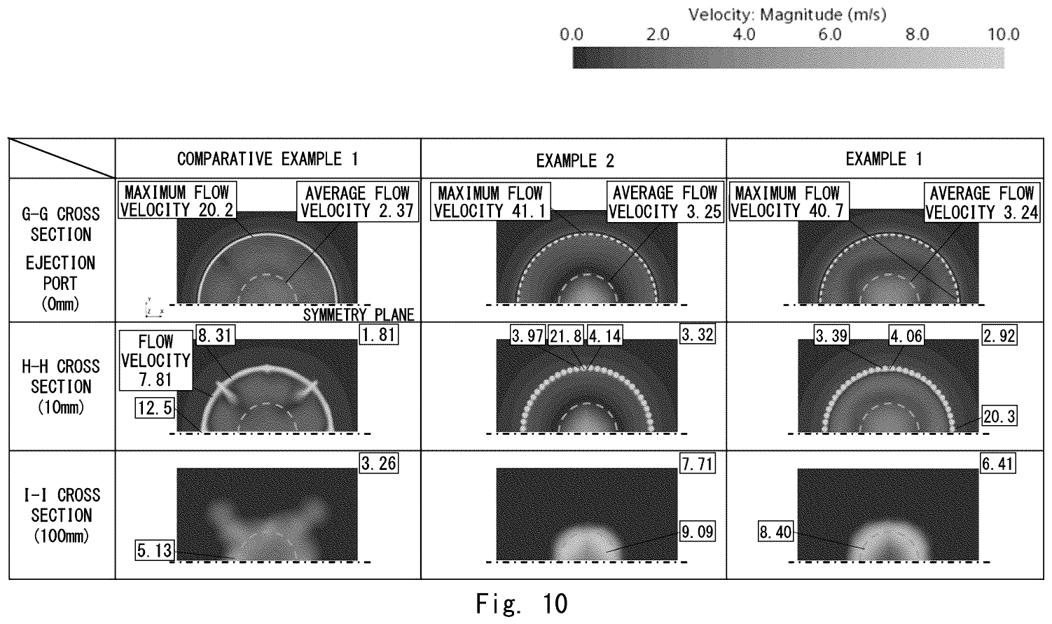

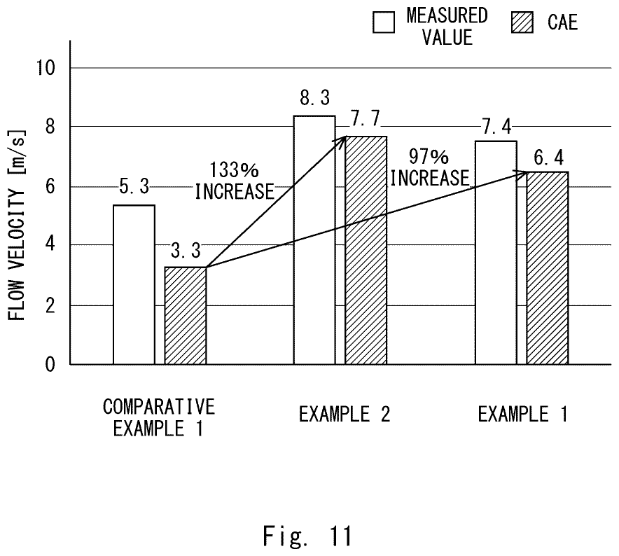

Next, results of analyses and experiments carried out for Example 1, Example 2, and the like will be described with reference to FIGS. 6 to 11. FIG. 6 shows places where a flow velocity was analyzed in an example. FIG. 7A shows a result of an analysis of a flow velocity in Example 1. FIG. 7B shows a result of an analysis of a flow velocity in Example 2. FIG. 7C shows a result of an analysis of a flow velocity in Comparative Example 1. FIG. 8 shows places where a flow velocity was analyzed in an example. FIG. 9 shows a cross section where the flow velocity was analyzed in the example. FIG. 10 shows results of analyses of flow velocities in the example. FIG. 11 is a graph showing results of measurements or analyses of flow velocities below a protective optical member of a laser welding apparatus according to an example and the like.

Note that although the configurations of the laser welding apparatuses 100, 100a, and 900 were used as they were for the sake of the explanation below, these configurations show corresponding configurations in Examples 1 and 2, and Comparative Example 1, respectively.

Example 1 is a laser welding apparatus having the same configuration as that of the laser welding apparatus 100 shown in FIGS. 1 to 4. Example 2 is a laser welding apparatus having the same configuration as that of the laser welding apparatus 100a shown in FIG. 5. The welding atmosphere is air, and the air is supplied to the upper-side gas supply units 1 and 21 and the lower-side gas supply unit 2.

In Example 1, flow velocities on a cross section D1 shown in FIG. 6 when gas was ejected from the first ejection ports 1c, the second ejection ports 1d, and the ejection ports 2c were calculated by using a CAE (Computer-Aided Engineering) analysis. The results of the calculation are shown in FIGS. 7A, 7B, and 7C. Note that it was verified that the results of calculation of the flow velocities on the cross section including the axis Z1 shown in FIG. 6 were almost the same as the results shown in FIGS. 7A, 7B, and 7C. Similarly, in Example 2, flow velocities on a cross section corresponding to the one shown in FIG. 6 when the first ejection ports 1c, the third ejection ports 1e, and the ejection ports 2c ejected gas were calculated by using a CAE analysis. The results of the calculation are shown in FIGS. 7A, 7B, and 7C. In each of Examples 1 and 2, the amounts of gas supplied to the upper-side gas supply units 1, 21, and the lower-side gas supply unit 2 were equal to each other.

Further, regarding Example 1, FIG. 10 shows calculated flow velocities on each cross section, shown in FIG. 9, of a columnar body having a semicircular cross section having a diameter of 70 mm centered at the axis Z1 of the cylindrical part 4b shown in FIG. 8. Similarly, regarding Example 2, FIG. 10 shows calculated flow velocities on each cross section shown in FIG. 9.

Further, in Examples 1 and 2, the results of measurement of average flow velocities at a position of 100 mm from the ejection port 2c, i.e., an I-I cross section, and the results of calculation using a CAE analysis are shown in FIG. 11.

Note that Comparative Example 1 is a laser welding apparatus having the same structure as that of the laser welding apparatus 900 shown in FIGS. 12 to 15. Similarly to Examples 1 and 2, the welding atmosphere was air, and the air was supplied to the upper-side gas supply unit 91 and the lower-side gas supply unit 92. Similarly, in Comparative Example 1, flow velocities on a cross section corresponding to the one shown in FIG. 6 when the obliquely-downward ejection port 91c and the obliquely-downward ejection port 92c ejected gas were calculated by using a CAE analysis. The results of the calculation are also shown in FIGS. 7A, 7B, and 7C. Similarly, regarding Comparative Example 1, calculated flow velocities on cross sections corresponding to those shown in FIG. 9 are shown in FIG. 10. Similarly, the result of measurement of an average flow velocity at a position of 100 mm from the obliquely-downward ejection port 92c corresponding to the ejection port 2c and the result of calculation using a CAE analysis are shown in FIG. 11.

As shown in FIG. 7C, in Comparative Example 1, a part of air flowed upward toward the plate-like part 94a near the underside of the plate-like part 94a. Further, a part of this air flowed toward the obliquely-downward ejection port 91c along the surface of the plate-like part 94a.

In contrast, as shown in FIG. 7A, in Example 1, any flow that rose toward the plate-like part 4a could not be observed near the underside of the plate-like part 4a. Further, in Example 1, it can be verified that another flow(s) of air reached the center of the plate-like part 4a from the first ejection ports 1c along the underside of the plate-like part 4a, and then flowed downward with respect to the plate-like part 4a. Similarly, as shown in FIG. 7B, such a flow (i.e., a flow that rose toward the plate-like part 4a) could not be observed in Example 2. Further, in Example 2, it can be verified that another flow(s) of air reached the center of the plate-like part 4a from the first ejection ports 1c along the underside of the plate-like part 4a, and then flowed downward with respect to the plate-like part 4a. By these flows, it is possible to prevent fumes from rising and reaching the underside of the plate-like part 4a.

As shown in FIG. 7A, in Example 1, it can be verified that a part of air flowed so as to rise toward the plate-like part 4a below the outer edge of the plate-like part 4a. In contrast, as shown in FIG. 7B, in Example 2, such a flow could be hardly verified. From these facts, Example 2 can prevent fumes from rising and reaching the underside of the plate-like part 4a more effectively than Example 1 can.

As shown in FIG. 10, in G-G, H-H, and I-I cross sections, most of the flow velocities in Examples 1 and 2 were higher than those in Comparative Example 1. Further, in the G-G, H-H, and I-I cross sections, most of the flow velocities in Example 2 were higher than those in Example 1.

As shown in FIG. 11, in the I-I cross section, the flow velocities calculated by a CAE analysis are, from the highest side, in the order of Example 2, Example 1, and Comparative Example 1. Similarly, in the I-I cross section, the measured flow velocities are, from the highest side, in the order of Example 2, Example 1, and Comparative Example 1.

Note that the present disclosure is not limited to the above-described embodiments, and they can be modified as appropriate without deviating from the scope and spirit of the disclosure. Further, the present disclosure may be implemented by combining the above embodiments and their examples as appropriate with one another.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A laser welding apparatus comprising:
a laser scanner; and
a protective optical member disposed between the laser scanner and a workpiece, wherein
the laser welding apparatus further comprises:
an upper-side gas supply unit; and
a lower-side gas supply unit disposed below the upper-side gas supply unit,
the protective optical member includes a plate-like part and a cylindrical part extending downward from an outer edge of the plate-like part,
the upper-side gas supply unit is disposed below the plate-like part of the protective optical member,
the upper-side gas supply unit includes a plurality of first ejection ports configured to eject gas to a center of the plate-like part, and a plurality of second ejection ports configured to eject gas downward with respect to the plate-like part,
the cylindrical part is disposed between the upper-side gas supply unit and the lower-side gas supply unit, and includes a plurality of gas feeding ports for feeding gas from an outside of the cylindrical part into an inside thereof, and
the lower-side gas supply unit includes a plurality of lower-side ejection ports configured to eject gas downward from a lower end of the cylindrical part.

2. The laser welding apparatus according to claim 1, wherein the plurality of second ejection ports eject gas from the outer edge of the plate-like part in a direction inclined toward an optical axis of the laser.

3. The laser welding apparatus according to claim 1, wherein the plurality of second ejection ports eject gas from the outer edge of the plate-like part in a direction parallel to an optical axis of the laser.
